(19) United States
(12) Patent Application Publication
(10) Pub. No.: US 2016/0155082 A1
(43) Pub. Date: Jun. 2, 2016

(54) ESTIMATING DIMENSIONAL WEIGHT OF A PACKAGE

(71) Applicant: David Calvin Kieffer, Marysville, OH (US)

(72) Inventor: David Calvin Kieffer, Marysville, OH (US)

(21) Appl. No.: 14/693,169

(22) Filed: Apr. 22, 2015

Related U.S. Application Data
(60) Provisional application No. 62/085,845, filed on Dec. 1, 2014.

(51) Int. Cl. G06Q 10/08

(52) U.S. Cl. CPC G06Q 10/083

(57) ABSTRACT

A computer implemented method for estimating the dimensional weight of a package is disclosed. The method provides a user interface for inputting one or more dimensional attributes of the package such as length, width, height and mass weight of the package. The net dimensional weight of the package is determined using an algorithm that includes calculating a first value by multiplying the length, width and the height of the package; calculating a second value by dividing the first value by the dimensional weight constant and calculating the dimensional weight of the package by subtracting the mass weight of the package from the second value.

### CROSS REFERENCE

The present invention is taking reference of provisional patent application No. 62/085,845 dated Dec. 1, 2014 entitled “METHOD OF DETERMINING DIMENSIONAL WEIGHT OF PACKAGES.”

### FIELD OF INVENTION

The present invention relates to a system and a method for determining dimensional weight of packages. More specifically, the present invention relates to a method for determining dimensional weight by providing a user interface for inputting dimensional weight attributes.

### BACKGROUND OF THE INVENTION

The theory of dimensional weighing of the packages is well known in the prior art. There are many systems and methods available in the prior art relating to the dimensional weighing of the packages for calculating the appropriate shipping amount.

Currently, many websites offering the dimensional weight calculation are not completely handling the dimensional process involving variables and mass weight. Many websites go on to make this process very complicated to the average person, most only know that it usually cost more money but don't know the efficiency the process offers. Further, the websites provides limited use of units for the calculation of dimensional weight. It is tedious to convert them in common units as available with the system. Further, the abbreviations that are used for the dimensions are generally awkward for a computer program user and lay people to understand.

Further, it is required that the packaging technology should be more aware of appropriate excess volume packages for storing items at Manufacturing Plant, transportation in plant, between plants, storing in warehouse, storing in receiving docks to establish a cost for excess volume packages to Mass Weight impacts.

Therefore, there is a need for an improved system and method capable of effectively estimating the dimensional weight of the packages for billing purposes. Further, there is a need for an improved system and method that can enable the user to input dimensions of the package in one or more units of physical quantities based on the user's requirement.

### SUMMARY OF INVENTION

The invention under study is directed towards a system and a method for effectively determining the dimensional weight of the packages. The present invention discloses a computer implemented method for estimating the dimensional weight of a package comprising: providing an user interface for inputting the dimensional attributes of the package; inputting the dimensional attributes such as length, width, height and mass weight of the package; determining the net dimensional weight of the package; determining whether the package is under the dimensional weight consideration in such way that if the net dimensional weight of the package is positive, the dimensional weight of the package exists; if the net dimensional weight of the package is negative, the dimensional weight of the package does not exist.

It is an object of the present invention to provide an algorithm that comprises calculating the first value by multiplying the length, width and the height of the package; calculating the second value by dividing the first value by the dimensional weight constant and calculating the dimensional weight of the package by subtracting the mass weight of the package from the second value.

It is another object of the present invention to provide a system for estimating the dimensional weight of the package, the system comprising: a processor to execute instructions stored in a storage medium wherein the storage medium comprises instructions for performing aforementioned method.

It is a further object of the present invention to provide a computer program product for estimating the dimensional weight of a package by a computing device, the computer program product comprising at least one non-transitory computer-readable storage medium having computer-readable program code portions stored therein, said computer-readable program code portions comprising instructions for performing the aforementioned method.

Some or all of the aforementioned advantages of the invention are accrued by configuring a user interface for inputting the dimensional attributes in one or more selectable units of physical quantity.

Further advantages and features of the present invention are considered by determining the ratio multiplier by dividing the mass weight of the package to the net dimensional weight of the package when the net dimensional weight of the package is positive and by dividing the mass weight of the package to the gross dimensional weight of the package when the net dimensional weight of the package is negative.

### BRIEF DESCRIPTION OF DRAWINGS

The features of the present invention, which are believed to be novel, are set forth with particularity in the appended claims. The invention may best be understood by reference to the following description, taken in conjunction with the accompanying figures. These figures and the associated description are provided to illustrate some embodiments of the invention, and not to limit the scope of the invention.

In the following the invention will be described in greater detail with reference to exemplary embodiments in accordance with the accompanying drawings, in which:

FIG. 1 demonstrates a flow chart representing for estimating the dimensional weight of a package in accordance with an embodiment of the present invention;

FIG. 2 demonstrates a flow chart representing an algorithm for calculating the net dimensional weight of the package in accordance with another embodiment of the present invention;

FIG. 3 demonstrates a system for estimating the dimensional weight of a package in accordance with another embodiment of the present invention.

FIG. 4 demonstrates a user interface for inputting the dimensional attributes of the package in accordance with another embodiment of the present invention.

The features of the invention illustrated above and below in the specification, are described with reference to the drawings summarized above. The reference numbers shown in the drawings may be used at one or more places to indicate the functional relation between the referenced elements. Some of the embodiments are described in the dependent claims.

### DETAILED DESCRIPTION OF THE EMBODIMENTS

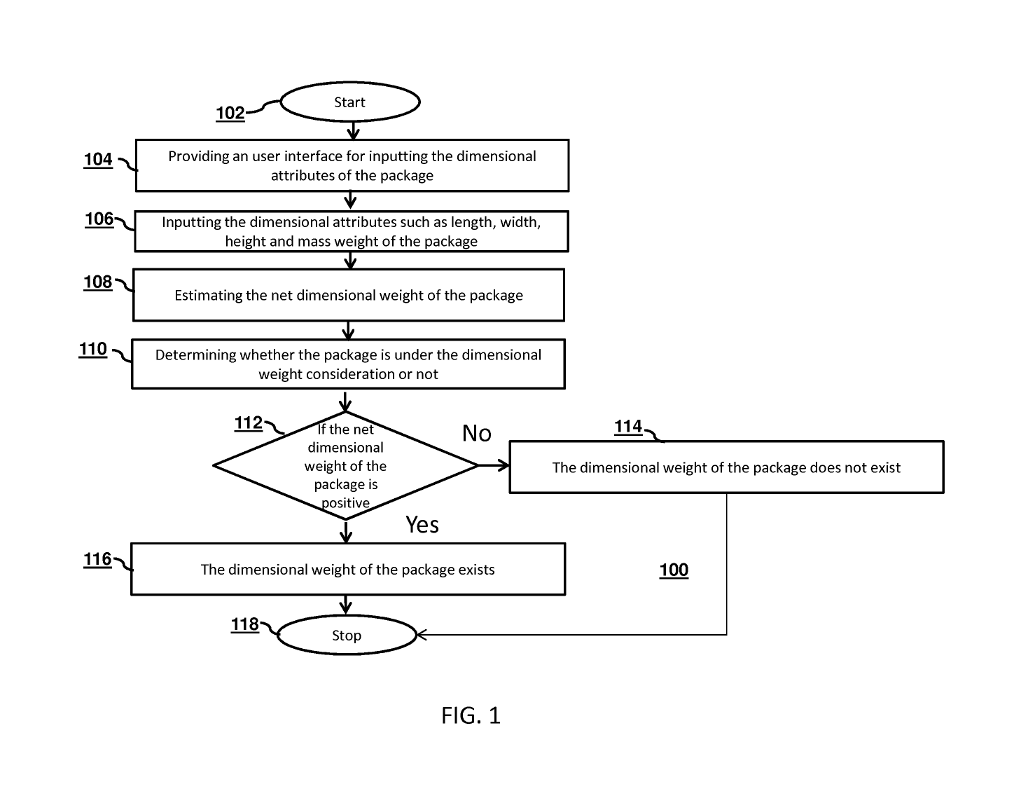

The following detailed description is merely exemplary in nature and is to enable any person skilled in the art to make and use the invention. The examples shown in description are not intended to limit the application and uses of the various embodiments. Various modifications to the disclosed invention will be readily apparent to those skilled in the art, and the methodology defined herein may be applied to other embodiments and applications without departing from the spirit and scope of the present disclosure. Thus, the present invention is not limited to the examples shown, but is to be accorded the widest scope consistent with the methodology and features disclosed herein. It should also be noted that FIGS. 1-4 are merely illustrative and may not be drawn to scale.

The present invention relates to the concept of estimating the dimensional weight to determine the charge required for transporting a package, and more particularly to a system for estimating the dimensional weight that is suitable for the use by the shippers to determine accurate consignment charges for packages that are considerably having excess dimension weight in comparison to their actual weight.

Embodiments of the present invention provide a system and a method for effectively estimating the dimensional weight of a package. Referring to FIG. 1, an embodiment of the present invention provides a method 100 for estimating the dimensional weight of a package. The method initiates at step 102. In step 104, a user interface is provided for inputting the dimensional attributes of the package. In step 106, a user inputs the dimensional attributes in to the system.

In an embodiment of the present invention, the dimensional attributes include one or more of length, width, height, mass weight of the package and the combination thereof.

In step 108, the system estimates the net dimensional weight of the package. Further, in step 110, the system determines whether the package is under the dimensional weight consideration or not. In step 112, the system determines if the net dimensional weight of the package is positive or not. If the net dimensional weight of the package is not positive, it is concluded in the step 114 that the net dimensional weight of the package does not exist and the method ends at step 118. If the net dimensional weight of the package is positive, it is concluded in the step 116 that the net dimensional weight of the package exists and the method ends at step 118.

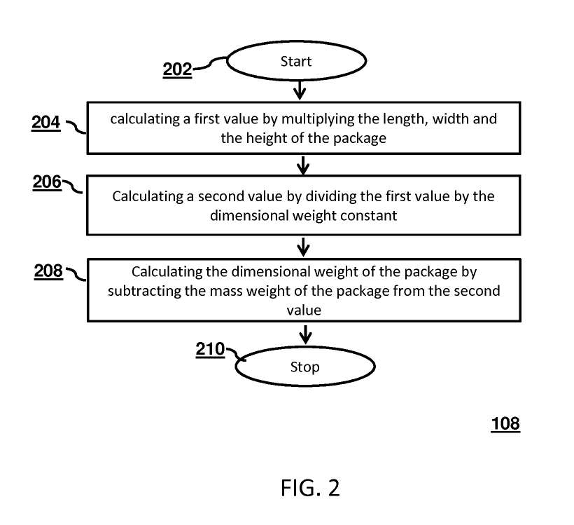

Referring to FIG. 2 of the present invention, (as mentioned above in step 108 of FIG. 1) the net dimensional weight of the package is determined by an algorithm. The algorithm includes the steps and initiates at step 202. At step 204, a first value is calculated by multiplying the length, width and the height of the package. Further at step 206, a second value is calculated by dividing the first value by the dimensional weight constant. The dimensional weight constant is selectable from USA (1#DCUSA) or international (1#DCIN) or other determined classes derived from original sources of dimensional weight.

In an embodiment of the present invention, the algorithm is used for determining dimensional weight for the shipping purposes. Further, the present invention may be used in the manufacturing process to increase value and efficiency. This algorithm may be written in any software programs, Basic, C, C++, Java, Excel, etc., embedded into Web pages.

In an exemplary embodiment of the present invention, if the Dimensional Weight output calculated for a package according to the aforementioned algorithm is negative then that package is not Dimensional Weight consideration, but output can be used to assist a provider to the item for further usable solutions.

In an embodiment of the present invention, the user may recognize how the 1#(pound) USA & International constant are formulated, so future needs for other classes of Dimensional Weight will be smooth connection to all other user needs. The user may further analyze how to establish Dimensional Weight Automation, Calibration standard, a cube of 12″×12″×12″ made hollow with outer sides of aluminum or magnesium material.

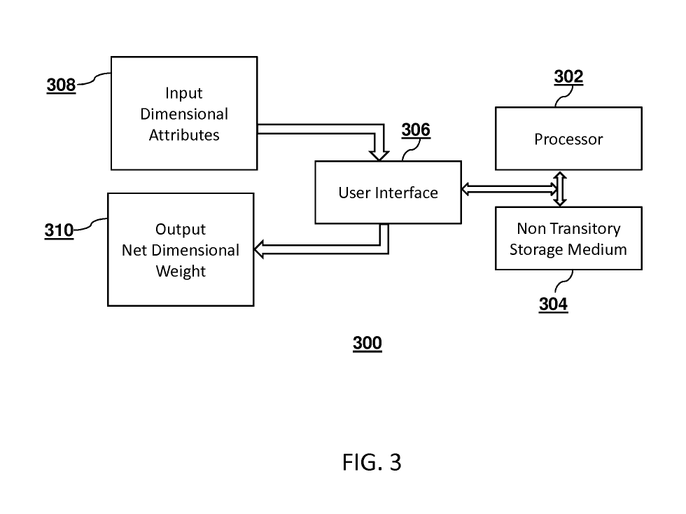

Referring to FIG. 3, an embodiment of the present invention discloses a system 300 for estimating the dimensional weight of a package. The system 300 includes a processor 302 to execute instructions stored in a non-transitory storage medium 304 wherein the non-transitory storage medium comprises instructions for performing the aforementioned method 100 and the algorithm. The system further includes a user interface 306 for enabling the user to interact with the system 300. Through the user interface, the user is enabled to input the dimensional attributes 308 and to output the net dimensional weight 310.

The non-transitory storage medium 304 may be any device that can store code to use by a computer system, mobile and others. The non-transitory storage medium 304 may include, but is not limited to a volatile memory, non-volatile memory, magnetic and optical storage devices such as disk drives, magnetic tape, CDs (compact discs), DVDs (digital versatile discs or digital video discs), or other media capable of storing code now known or later developed.

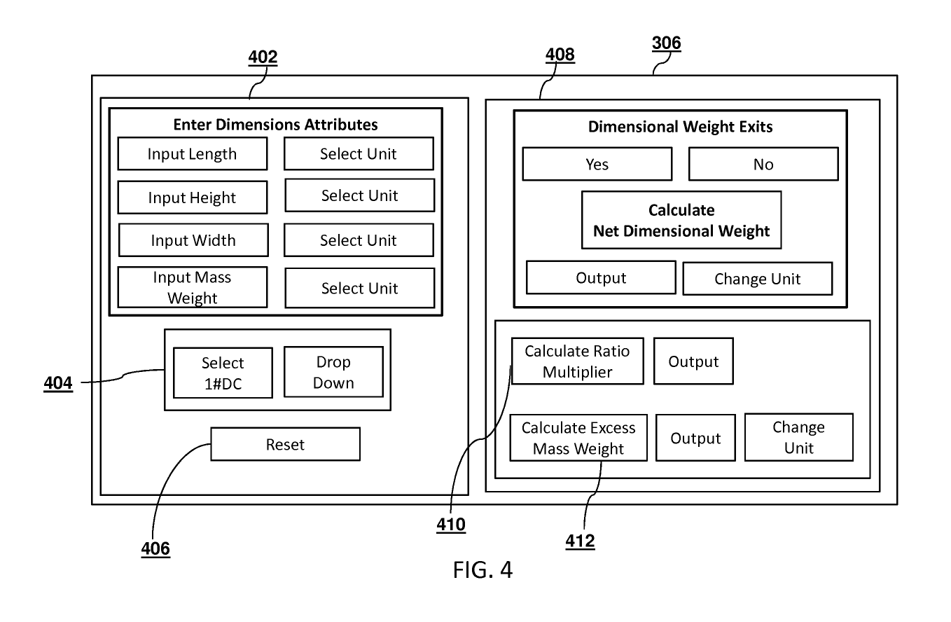

Referring to FIG. 4, in an embodiment of the present invention, the user interface 306 includes input and output fields. The input fields 402 includes field to enter dimension attributes such as length, height, width and mass weight. The user may select the units for each dimension attributes. In other embodiments of the present invention, the units can be default units as per the unit used in particular geographical area. Further, the user interface 306 includes the fields for selecting the dimensional constants (1#DC).

In an embodiment of the present invention, the selection can be made either from a drop down list or from the pop up menu of the dimensional constant.

In an embodiment of the present invention, the user further includes a “reset” field 406 to reset the filled dimensional attributes.

Further, the user interface 306 includes the output field 408 that shows whether the dimensional weight exists or not. In the output field the user may calculate and visualize the net dimensional weight. The net dimensional weight can be calculated either in default unit or unit can be changed by clicking on/selecting the change unit field.

Further, the output field 408 includes a “calculate a ratio multiplier” field 410 and a “calculate excess mass weight” field 412.

In an exemplary embodiment of the present invention, the dimension attributes may be inputted as length in inches, width in inches, and the height in inches, mass weight in pounds to two decimal places and the dimensional constant in 1 pound constant (1#NDWUSA), or 1 pound constant International (1#NDWIN). In the embodiment, the outputs of net dimensional weight (NDW), gross dimensional weight (GDW) are calculated. In other embodiment of the present invention, the optional information can be calculated such as ratio multiplier (RMDW), offering a quick reference that the net weight of the package is over by a ratio multiplier or %, when the (NDW) is true.

In an embodiment of the present invention, an optional ratio multiplier for mass weight can be calculated by the ratio of mass weight (MW) and gross dimensional weight (GDW). This will indicate the ratio multiplier of Excess Mass Weight (EMW) or %.

In an embodiment of the present invention, the user interface 306 may be a display device that provides the facility to the user to select one or more aforementioned fields. In other embodiments of the present invention, the user interface 306 can be any hardware and/or computer program and the combination thereof which may enable the user to interact with the system 300. The user interface 306 may include one or more of a display screen, keyboard, mouse, light pen, the appearance of a desktop, help messages, and how an application program or a web site invites interaction and responds to it.

An exemplary embodiment of the present invention enabled the user to know the Mass Weight of the item by using a known NIST sourced calibrated scale. The volume can be determined by measuring item with a NIST sourced inches ruled standard. The division (1#DC) 1 pound constant shall be selected from USA (1#DCUSA) or International (1#DCIN) classes or other determined select classes derived from original sources of Dimensional Weight.

This value then will be subtracted by mass weight which produces a positive or a negative net dimensional weight. A negative (−NDW) reflects that no further consideration of volume impact from this package to combination to items. A positive (+NDW) reflects a true dimensional weight and further considerations to its volume to added impact on further process of the package, till arrival at planned location, in a factory, in a warehouse, on transportation, location storage, location usage. The positive NDW can be added to the mass weight and multiplied by the 1 pound DC (1#DC) to reflect on the package volume represented. The dimensional weight of positive NDW can be added to other packages to determine the volume to weight ratio for maximum weight to be handled in a minimum volume or space. For example, large volume excess of a quantity of packages means small weight combination so to plan large volume on package a converging path is required.

In a further exemplary embodiment of the present invention, the aforementioned algorithm is stored in the non-transitory storage medium as a computer program executes in a way to allow the user to input length, width, height; Mass Weight, and 1 pound Dimensional Constant for assigned classes. Further, system 300 develops the gross dimensional weight and net dimensional weight as output. The system 300 allow the user to Print to screen, and printer programming, Print condensed information of the packages to be saved. The system allows the user to take off formulas from NDW and GDW tabulation and other formats to provide model development for 1#DC_{— — —}, order of reasoning from 1000# max container to proven 1#DC_{— — —} & for developing the model for other future classes.

In another embodiment of the present invention, the system 300 may be any computing device that includes a user interface to allow the user to input and/or output data and may be connected to internet and/or other data sharing networks either itself or by using some dedicated device.

A further embodiment of the present invention provides a computer program product for estimating the dimensional weight of a package by a computing device, the computer program product comprising at least one non-transitory computer-readable storage medium having computer-readable program code portions stored therein, said computer-readable program code portions comprising instructions for performing the aforementioned method 100 and the algorithm.

The system 300 and method 100 described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer.

It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

Though exemplary embodiments have been presented in the foregoing detailed description of the invention, it should be appreciated that a vast number of variations exist. It should also be note that the disclosed embodiments and methods are not intended to limit the scope and applicability of the invention in any way.

Rather, the foregoing detailed description will provide those skilled in the art with a convenient road map for implementing an exemplary embodiment of the invention, it being understood that various changes may be made in the methods and order of steps described in an exemplary embodiment without departing from the scope of the invention as set forth in the appended claims and their legal equivalents.

1. A computer implemented method for estimating the dimensional weight of a package comprising:
providing a user interface for inputting one or more dimensional attributes of the package;
inputting the one or more dimensional attributes of the package;
determining a net dimensional weight of the package;
determining whether the package is under a dimensional weight consideration in such a way that:
if the net dimensional weight of the package is positive then the dimensional weight of the package exists; and
if the net dimensional weight of the package is negative then the dimensional weight of the package does not exist.
determining a ratio multiplier for estimating the excess mass weight of the package.

2. The computer implemented method as claimed in claim 1, wherein the one or more dimensional attributes can be inputted in one or more selectable units of physical quantity.

3. The computer implemented method as claimed in claim 1, wherein the dimensional weight of the package is determined by an algorithm; the algorithm comprises:
calculating a first value by multiplying the length, width and the height of the package;
calculating a second value by dividing the first value by the dimensional weight constant;
calculating the dimensional weight of the package by subtracting the mass weight of the package from the second value.

4. The computer implemented method as claimed in claim 3, wherein the dimensional weight constant is selectable from USA (1#DCUSA) or international (1#DCIN) or other determined classes derived from original sources of dimensional weight.

5. The computer implemented method as claimed in claim 1 further comprising determining a ratio multiplier for estimating the excess mass weight of the package.

6. The computer implemented method as claimed in claim 5 wherein the ratio multiplier is determined by dividing the mass weight of the package to the net dimensional weight of the package when the net dimensional weight of the package is positive.

7. The computer implemented method as claimed in claim 5, wherein the ratio multiplier is determined by dividing the mass weight of the package to the gross dimensional weight of the package when the net dimensional weight of the package is negative.

8. The computer implemented method as claimed in claim 1 further comprising determining volume of the package when the net dimensional weight is negative by multiplying the gross dimensional weight with the dimensional weight constant.

9. A system for estimating the dimensional weight of a package, the system comprising:
a processor to execute instructions stored in a non-transitory storage medium wherein the non-transitory storage medium comprises instructions for:
providing a user interface for inputting one or more dimensional attributes of the package;
inputting the one or more dimensional attributes of the package;
determining a net dimensional weight of the package;
determining whether the package is under the dimensional weight consideration in such way that:
if the net dimensional weight of the package is positive, the dimensional weight of the package exists;
if the net dimensional weight of the package is negative, the dimensional weight of the package does not exist.
determining a ratio multiplier for estimating the excess mass weight of the package.

10. The system computer as claimed in claim 9, wherein the one or more dimensional attributes can be inputted in one or more selectable units of physical quantity.

11. The system computer as claimed in claim 9, wherein the dimensional weight of the package is determined by an algorithm; the algorithm comprises:
calculating a first value by multiplying the length, width and the height of the package;
calculating a second value by dividing the first value by the dimensional weight constant;
calculating the dimensional weight of the package by subtracting the mass weight of the package from the second value.

12. The system computer as claimed in claim 11, wherein the dimensional weight constant is selectable from USA (1#DCUSA) or international (1#DCIN) or other determined classes derived from original sources of dimensional weight.

13. The system as claimed in claim 9, wherein the storage medium further comprising instructions for determining a ratio multiplier for estimating the excess mass weight of the package.

14. The system as claimed in claim 13 wherein the ratio multiplier is determined by dividing the mass weight of the package to the net dimensional weight of the package when the net dimensional weight of the package is positive.

15. The system as claimed in claim 13 wherein the ratio multiplier is determined by dividing the mass weight of the package to the gross dimensional weight of the package when the net dimensional weight of the package is negative.

16. The system as claimed in claim 9 wherein the storage medium is further comprising instructions for determining volume of the package when the net dimensional weight is negative by multiplying the gross dimensional weight with the dimensional weight constant.

17. A computer program product for estimating the dimensional weight of a package by a computing device, the computer program product comprising at least one non-transitory computer-readable storage medium having computer-readable program code portions stored therein, said computer-readable program code portions comprising instructions for:
providing a user interface for inputting one or more dimensional attributes of the package;
inputting the one or more dimensional attributes of the package;
determining a net dimensional weight of the package;
determining whether the package is under the dimensional weight consideration in such way that:
if the net dimensional weight of the package is positive, the dimensional weight of the package exists;
if the net dimensional weight of the package is negative, the dimensional weight of the package does not exist.
determining a ratio multiplier for estimating the excess mass weight of the package.

18. The computer program product as claimed in claim 17, wherein the dimensional attributes can be inputted in one or more selectable units of physical quantity.

19. The computer program product as claimed in claim 17, wherein the one or more dimensional weight of the package is determined by pre-defined algorithm; the algorithm comprises:
calculating a first value by multiplying the length, width and the height of the package;
calculating a second value by dividing the first value by the dimensional weight constant;
calculating the dimensional weight of the package by subtracting the mass weight of the package from the second value.

20. The computer program product as claimed in claim 17, wherein the dimensional weight constant is selectable from USA (1#DCUSA) or international (1#DCIN) or other determined classes derived from original sources of dimensional weight.
